(19) United States
(12) Patent Application Publication
(10) Pub. No.: US 2026/0121948 A1
(43) Pub. Date: Apr. 30, 2026

(54) USER ROLE-AWARE INTERACTIONS BY NETWORK TROUBLESHOOTING LLM AGENTS

(71) Applicant: Cisco Technology, Inc., San Jose, CA (US)

(72) Inventors: Eduard Schornig, Haarlem (NL); Jean-Philippe Vasseur, Combloux (FR); Pierre-André Savalle, Rueil-Malmaison (FR); Grégory Mermoud, Venthône (CH)

(73) Assignee: Cisco Technology, Inc., San Jose, CA (US)

(21) Appl. No.: 18/929,922

(22) Filed: Oct. 29, 2024

(51) Int. Cl. H04L 41/5022; H04L 41/0631; H04L 41/069; H04L 41/5006

(52) U.S. Cl. CPC H04L 41/5022; H04L 41/0631; H04L 41/069; H04L 41/5006

(57) ABSTRACT

In one implementation, a device obtains a prompt from a user via a user interface that requests a network troubleshooting agent complete a task with respect to a computer network using one or more language models. The device determines instructions for the network troubleshooting agent based on a user group of which the user is a member. The device provides the prompt and the instructions to the network troubleshooting agent, to produce an answer. The device provides the answer to the user interface for review by the user.

### TECHNICAL FIELD

The present disclosure relates generally to user role-aware interactions by network troubleshooting large language model (LLM) agents.

### BACKGROUND

Traditionally, network troubleshooting in many organizations is structured into multiple tiers (L1, L2, L3) based on the level of expertise and experience of support engineers, with each tier handling increasingly complex issues. When a new support ticket is initiated, it typically follows a tiered process. Initially, the ticket is assigned to an L1 support engineer who conducts basic checks and gathers initial information. If that engineer is unable to identify an obvious problem, they may then escalate the ticket to an L2 support engineer who collects more detailed data and conducts in-depth troubleshooting. Similarly, if the L2 support engineer is unable to identify the root cause and resolve the issue, they may further escalate the ticket to a higher-level support group (e.g., to an L3 support engineer).

The troubleshooting process can be time-consuming, as the issue is transferred between different layers of the support organization, or even different specialized domain experts or teams. This is especially true for complex issues where identifying the root cause is challenging and may require traversing all support tiers. Another drawback of this typical approach is that it can result in wasted time and resources, as multiple engineers may concurrently investigate the same issue or set of related issues.

The recent breakthroughs in large language models (LLMs), such as ChatGPT and GPT-4, represent new opportunities in the field of network troubleshooting. However, different users may differ considerably in terms of their expectations and needs when interacting with an LLM-based network troubleshooting system. For instance, an end user inquiring about poor wireless performance may be satisfied with a confirmation that there is an issue affecting access points, whereas a network administrator may want detailed information as to which access points are affected, their logs, etc.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example software defined network (SDN) implementation;

FIG. 5 illustrates an example architecture for a large language model (LLM)-based agent as a virtual network troubleshooting assistant;

FIG. 6 illustrates an example of the interactions of the components of the architecture in FIG. 5;

FIG. 7 illustrates an example architecture for supporting user role-aware interactions within an LLM-based network troubleshooting agent;

FIG. 8 illustrates an example of user-aware task scheduling for an LLM-based network troubleshooting agent; and

FIG. 9 illustrates an example simplified procedure for providing user role-aware interactions by LLM-based network troubleshooting agents.

### DESCRIPTION OF EXAMPLE IMPLEMENTATIONS

### Overview

According to one or more implementations of the disclosure, a device obtains a prompt from a user via a user interface that requests a network troubleshooting agent complete a task with respect to a computer network using one or more language models. The device determines instructions for the network troubleshooting agent based on a user group of which the user is a member. The device provides the prompt and the instructions to the network troubleshooting agent, to produce an answer. The device provides the answer to the user interface for review by the user.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

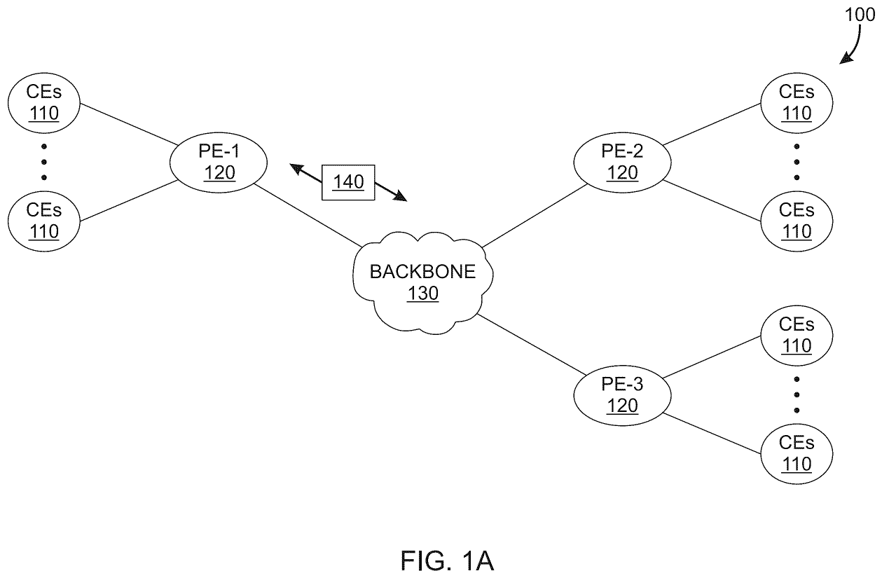

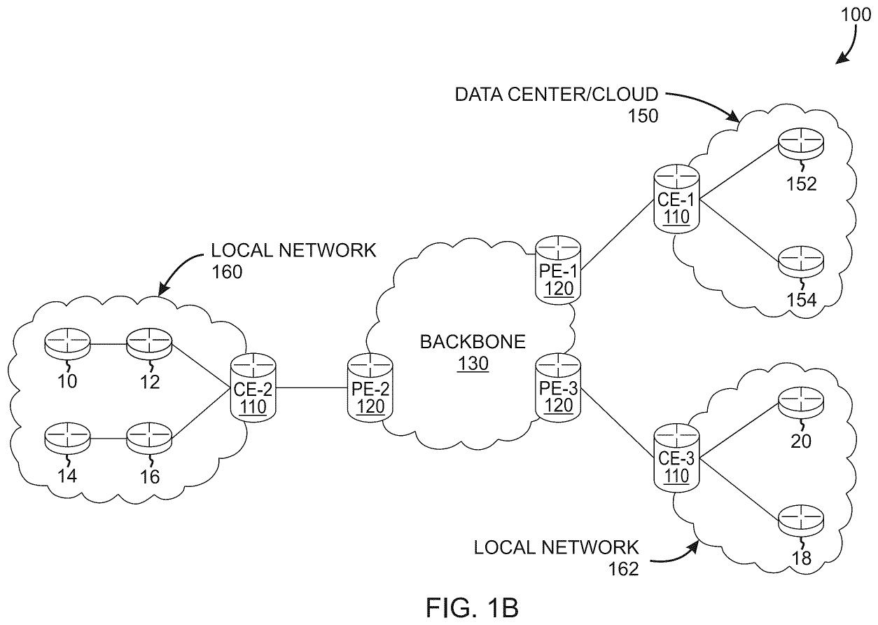

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

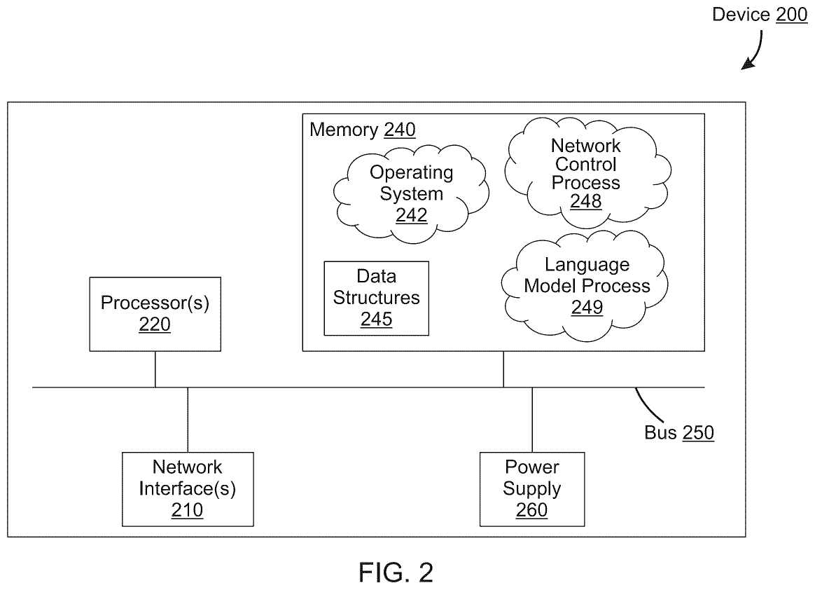

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a network control process 248 and/or a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In some instances, network control process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, network control process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, network control process 248 and/or language model process 249 may include computer executable instructions that, when executed by processor(s) 220, cause device 200 to perform the techniques described herein. To do so, in some implementations, network control process 248 and/or language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, network control process 248 and/or language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network control process 248 and/or language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, network control process 248 and/or language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network control process 248 may use a generative model to generate synthetic network traffic based on existing user traffic to test how the network reacts. Example generative approaches can include, but are not limited to, generative adversarial networks (GANs), large language models (LLMs) and other foundation models, transformer models, diffusion models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

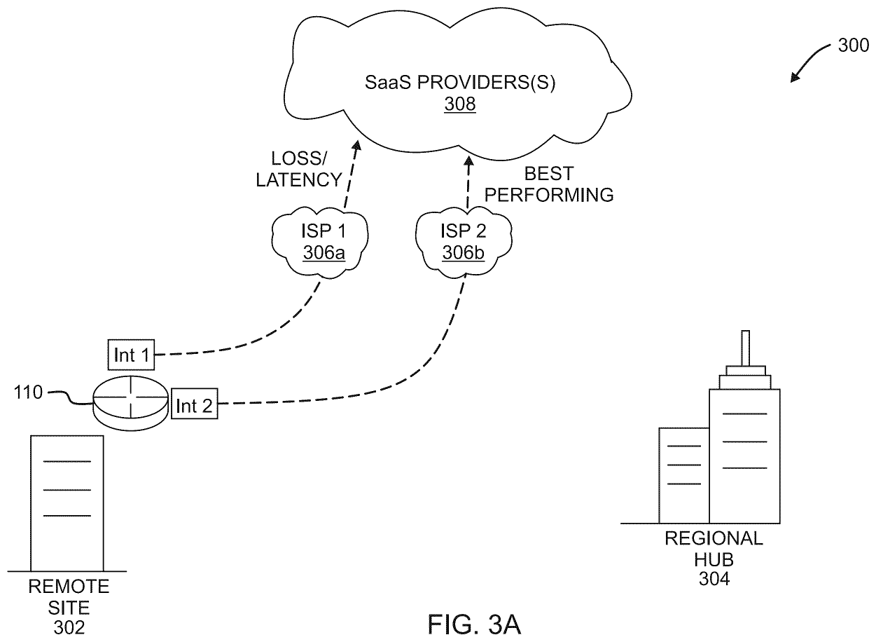

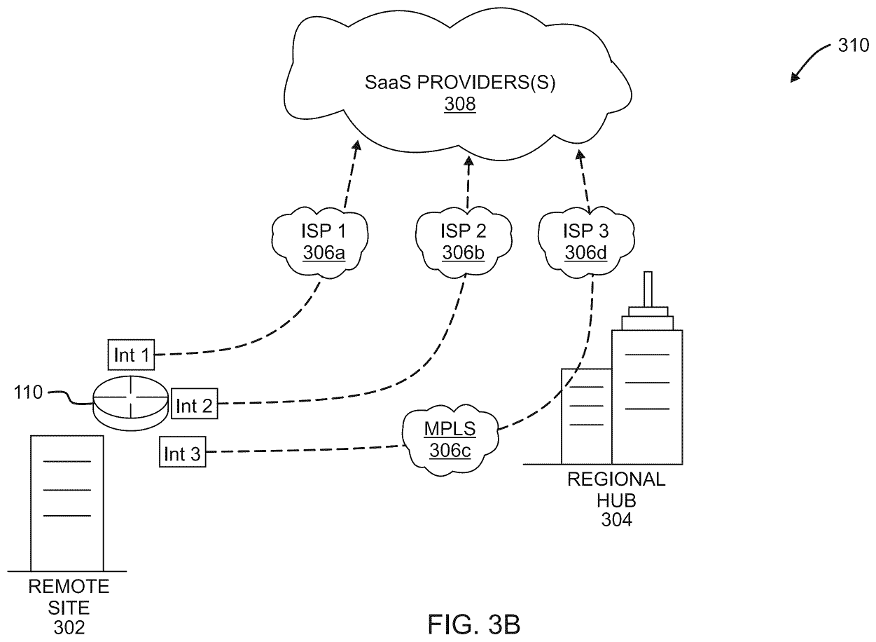

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

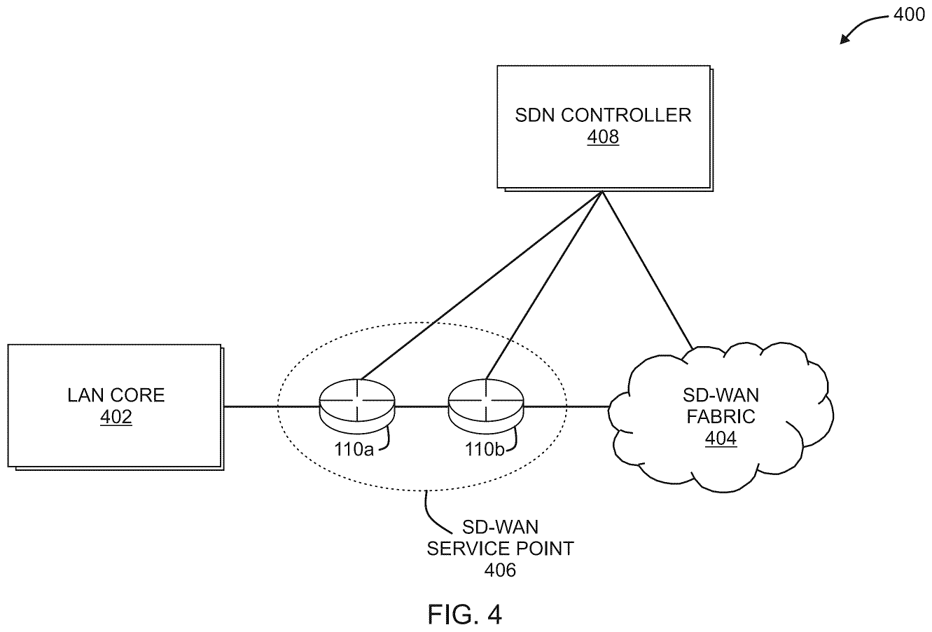

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., through execution of network control process 248), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As would be appreciated, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words, SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications).

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The introduction of plugins is a major development that enables LLM-based agents to interact with external systems and empower new domain-specific use cases. In the context of communication networks, the utilization of plugins allows LLMs to engage with documentation repositories, tap into knowledge bases, and interface with live network controllers and devices potentially opening the path to LLMs undertaking more complex tasks such as on-demand troubleshooting, device configuration, and performance monitoring. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

One area where LLM-based agents can offer substantial benefits is in the context of technical support for organizations. Traditionally, network troubleshooting in many organizations is structured into multiple tiers (L1, L2, L3) based on the level of expertise and experience of support engineers, with each tier handling increasingly complex issues. When a new support ticket is initiated, it typically follows a tiered process. Initially, the ticket is assigned to an L1 support engineer who conducts basic checks and gathers initial information. If no obvious problem is identified, the ticket is then escalated to an L2 support engineer who collects more detailed data and conducts in-depth troubleshooting.

During the troubleshooting process, the engineer may also refer to past tickets to review the root causes and troubleshooting steps taken for similar issues. While modern ticketing systems can automatically identify related problems and reference them in the new ticket, it remains the responsibility of the support engineer to examine each issue and perform the necessary troubleshooting steps to determine whether the same root cause applies or if the problem is entirely new. If the L2 support engineer is unable to identify the root cause and resolve the issue, it may be further escalated to a higher-level support group.

This entire troubleshooting process can be time-consuming as the issue is transferred between different layers of the support organization, or even different specialized domain experts or teams. This is especially true for complex issues where identifying the root cause is challenging and may require traversing all support tiers. Another drawback of this typical approach is that it can result in wasted time and resources, as multiple engineers may concurrently investigate the same issue. For instance, in the case of network congestion at a large site, multiple users from that site may open support tickets in quick succession. Each ticket may be assigned to a different L1 support engineer, who then independently performs initial debugging tasks before potentially escalating the issue to a higher-level support team. In some cases, the L2 team may eventually recognize the similarity between the new tickets and analyze the collected information to identify common elements (such as the same site, equipment, WAN circuit, etc.), which can significantly narrow down the scope of the investigation. In other cases, these similarities may not be immediately apparent, leading to multiple L2 engineers investigating the same issue, simultaneously.

Accordingly, on receiving a new ticket or other request, the system introduced herein automatically generates step-by-step troubleshooting instructions by analyzing past similar issues and executes them in the network environment. This is achieved by leveraging plugins that allow troubleshooting agent 502 to fetch data via API integrations with network controllers (e.g., DNAC, ACI, SD-WAN) and/or monitoring systems (e.g., Network Management Systems). The primary goals are to either directly identify the root cause of the problem or, when direct identification is not feasible, gather pertinent information such as logs, network context, and performance statistics to facilitate the work of human support engineers. Finally, the system can categorize similar tickets based on common elements, such as site location, WAN gateway, circuit, or log patterns, or based on identified root causes. These groups of tickets are then consolidated into a master issue and escalated to the appropriate technical contacts for remediation.

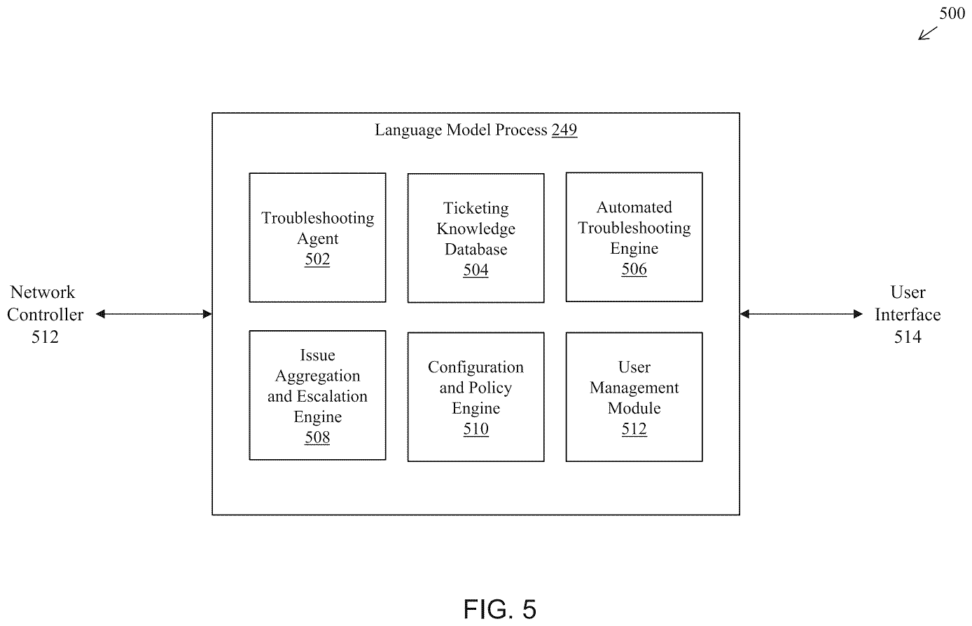

FIG. 5 illustrates an example architecture 500 for using a large language model (LLM)-based agent to provide self-healing capabilities to a network, according to various implementations. At the core of architecture 500 is language model process 249, which may be executed by a controller for a network or another device in communication therewith. For instance, language model process 249 may be executed by a controller for a network (e.g., SDN controller 408 in FIG. 4, a network controller in a different type of network, etc.), a particular networking device in the network (e.g., a router, a firewall, etc.), another device or service in communication therewith, or the like. For instance, as shown, language model process 249 may interface with a network controller 514, either locally or via a network, such as via one or more application programming interfaces (APIs), etc. In addition, language model process 249 may communicate with any number of user interfaces, such as user interface 516.

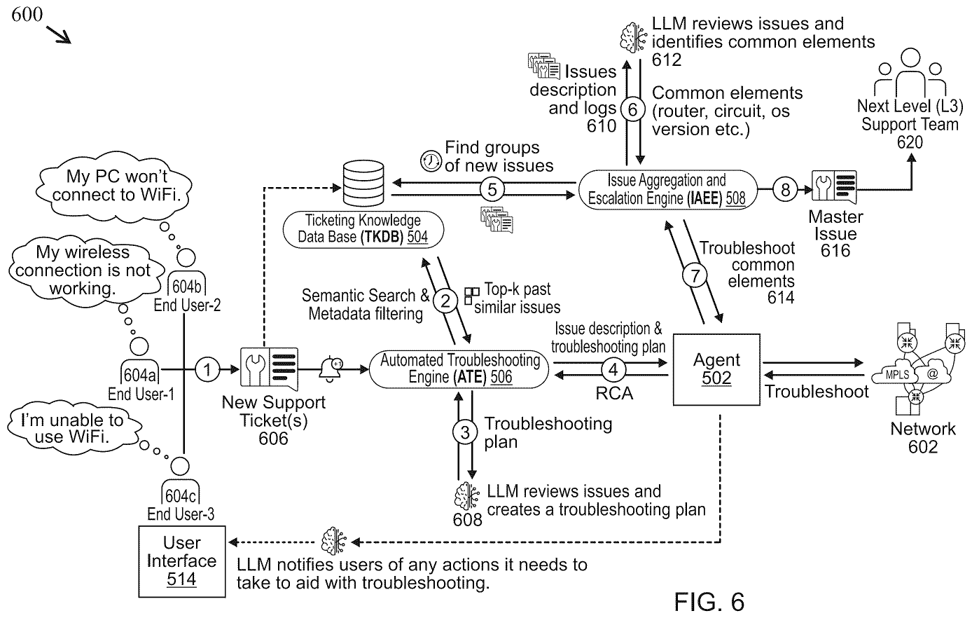

As shown, language model process 249 may include any or all of the following components: a troubleshooting agent 502, a ticketing knowledge database 504, an automated troubleshooting engine 506, an issue aggregation and escalation engine 508, a configuration and policy engine 510, and/or a user management module 512. As would be appreciated, the functionalities of these components may be combined or omitted, as desired. In addition, these components may be implemented on a singular device or in a distributed manner, in which case the combination of executing devices can be viewed as their own singular device for purposes of executing language model process 249. FIG. 6 illustrates an example 600 of the interactions of the components of architecture 500.

According to various implementations, troubleshooting agent 502 may leverage one or more LLMs to troubleshoot an issue, find the actual root cause for the issue, and/or suggest a set of one or more actions to fix the issue. Let ai denote an action used for troubleshooting an issue I and let Ai denote an action (configuration change) on the network (closed-loop control). In various instances, issue I may be raised by an end user, a set of users, or detected automatically within the network.

The set of actions Ai required to solve the issue I may be determined on-the-fly by the LLM of troubleshooting agent 502, statically determined according to a cookbook for each trajectory made of a set of action ai, or the like. For example, a static cookbook may be used to map a specific ak to set of actions Ak,l. Consider the action ak=“Check the priority queue length of a router,” a static set of action ak,l may be used to trigger a set of l action on the network (e.g., “Change the weight of the priority queue,” “Modify the WRED parameter for the high priority queue”). In another implementation, the system may discover the set of required actions related to a given root cause identified thanks to a set of action ai, using reinforcement learning or another suitable approach.

If the root cause identified by troubleshooting agent 502 for issue I is eligible for automated action (e.g., according to a policy), troubleshooting agent 502 may perform any or all of the following:
Troubleshooting agent 502 retrieves the set of action Ai for the root cause of issue I after activating a timer T (max time to solve the issue)
Troubleshooting agent 502 may also employ various optimization criterion may be used for solving a given task T. For instance, troubleshooting agent 502 may solve some tasks with objective metrics such as reducing the processing time or improve accuracy even at the risk of involving more steps and tokens (cost). In the context of the techniques herein, the issue criticality may also drive the optimization criteria (e.g., time versus reliability versus cost). In one implementation, the optimization criteria may be unique and decided according to policy and criticality. In another implementation, troubleshooting agent 502 may trigger multiple actions in parallel, each with different optimization criterion. For example, for a given issue I, troubleshooting agent 502 may send a request to a first LLM with a first criteria (e.g., solve as quickly as possible, optimizing time) and send the same request to a second LLM with different optimization criteria (e.g., efficiency). In such a case, troubleshooting agent 502 may use the reply to the first request (set of resolution action Ai) to quickly fix the network, followed by using the second set of actions to optimize the resolution of the issue. Note that both requests may not overlap in terms of closed-loop actions, as well.

In other words, during execution, troubleshooting agent 502 may take questions as input, runs one or more steps that can consist in calling an LLM, or retrieve data from external systems such as network controllers and monitoring systems, and produces an answer as output. To do so, troubleshooting agent 502 may rely on external APIs to obtain data required to perform troubleshooting and monitoring actions.

In various implementations ticketing knowledge database 504 may take the form of a vector database or other database that has the role of storing the text contents of support tickets as vector embeddings and facilitating semantic searches of said ticket history. For instance, ticketing knowledge database 504 may leverage a vector database such as Chroma or Pinecone to achieve this role and leverage either SaaS based embedding services such as OpenAI or local open-source embedding models to vectorize the ticket contents. Besides the vector embeddings, for each ticket, ticketing knowledge database 504 may also store additional information as metadata, such as any or all of the following:
State: Unassigned, Open, Closed (Resolved)
Issue category: Poor connectivity, No connectivity etc.
Technology domain: Security, Wired Access, Wireless Access, etc.
End user satisfaction: A reflection of how satisfied the user was with the support interaction usually as a 1 (low) to 5 (high) score.
Ticket key performance indicators (KPIs): Metrics such as time to resolution, that measure the total time taken to resolve the tickets or any other KPIs relevant for the specific support organization.

In various implementations, automated troubleshooting engine 506 may perform several tasks, when it receives a new support ticket:

In a first step, it queries ticketing knowledge database 504 for similar issues using a combination of semantic search and metadata filters. Automated troubleshooting engine 506 may identify relevant past issues based on a certain threshold of similarity, however it may use additional criteria such as user satisfaction score to narrow down the scope.

In a second phase, automated troubleshooting engine 506 may sends the ticket contents to an LLM (e.g., the LLM of troubleshooting agent 502) specifically tasked with extracting the troubleshooting steps performed in each of the identified similar tickets and compose a step-by-step troubleshooting plan. Based on the available LLM context size, this operation may be performed as one step, with all past tickets being included in the same LLM prompt or using multiple steps. In this second instance, troubleshooting steps for each ticket are extracted separately followed by a second query to the LLM which is asked to combine all the steps in a troubleshooting plan.

The resulting troubleshooting plan may resemble an inverted tree structure, with common steps that are executed universally at the top, such as identifying the site to which the user is connected, determining the connection type, and assessing the overall health status. These initial steps then branch out into several trajectories, each corresponding to potential root causes or specific troubleshooting paths. For example, these branches might involve verifying the health of the Wireless Access Point (AP), checking the uptime of the upstream switch, or assessing the load on the WAN connection, among other possibilities.

Furthermore, within each branch of the troubleshooting tree, there may exist two distinct types of steps:
1. Autonomous steps: these are sets of troubleshooting steps or actions that troubleshooting agent 502 can execute directly without requiring user intervention.
2. User Steps: these steps are actions that are part of the troubleshooting plan which need to be carried out by the end-users themselves. These actions might include actions like rebooting a host device or software client, modifying local configuration parameters, or collecting specific logs or information.

Next, automated troubleshooting engine 506 may send the troubleshooting plan to troubleshooting agent 502 that can interact with network controllers and monitoring systems to execute it and identify the root cause of the issue. To reduce the burden on the end user, troubleshooting agent 502 may be directed to initially explore the branches within the troubleshooting plan that exclusively consist of autonomous steps. This approach aims to identify the root cause without requiring any direct involvement from the end user. If, however, no root cause can be determined following the exploration of these autonomous branches, troubleshooting agent 502 may proceed to investigate branches that necessitate user interaction.

In such cases where user interaction is required, troubleshooting agent 502 may engage a user-facing LLM with the purpose of communicating with the end user. For instance, it may request that the end user perform certain actions, provide additional clarifications, or submit logs, thereby facilitating the troubleshooting process.

Upon completion of all the troubleshooting steps, two potential outcomes are possible:
Successful root cause identification: troubleshooting agent 502 successfully identifies the root cause of the issue. Automated troubleshooting engine 506 may engage with a system that aims to leverage automated self-healing capabilities to rectify the issue without human intervention. Alternatively, the root cause may be documented in the ticket and forwarded to a human support agent for remediation.
No root cause is identified: the second potential scenario arises when troubleshooting agent 502 is unable to successfully identify the root cause. In one embodiment, automated troubleshooting engine 506 handles this situation by initiating the entire process again, starting with a new query to the ticketing knowledge database 504 for a new set of similar issues. Additional filters may be specified to refine the search, excluding issues that match root causes (RCAs) that have already been ruled out. This process can be iterated multiple times, continuing until either a root cause is either discovered, or a predefined maximum number of attempts is reached. Alternatively, in a second embodiment, automated troubleshooting engine 506 may opt to utilize a system that facilitates the request for assistance from a human Subject Matter Expert (SME) when automated troubleshooting proves inconclusive.

In various implementations, issue aggregation and escalation engine 508 assumes the responsibility of continuously monitoring ticketing queues for the discovery of similar issues. Its primary function is to automatically aggregate similar issues into master tickets that can be quickly escalated to higher-level support teams.

Issue aggregation and escalation engine 508 may routinely query ticketing knowledge database 504 for tickets that are in an open state and employs clustering techniques, such as K-means clustering or Hierarchical Clustering, to group similar tickets together. These clusters represent sets of tickets that share common characteristics or problem descriptions.

When a new cluster of issues is identified, issue aggregation and escalation engine 508 may use an LLM to analyze the network information already collected with the tasks of identifying common network elements, such as a shared site, device, or circuit. For example, it may discover that all users reporting wireless issues are connected to the same site and wireless access point (AP). Additionally, it can identify common user environment elements, such as software versions, device types, or specific application issues. For instance, it might find that users with a particular device type are experiencing connectivity problems with the wireless network. In yet another instance, issue aggregation and escalation engine 508 may identify a combination of both network and user common elements such as all users with a specific software version have issues authenticating when using APs connected to a certain wireless controller (WLC).

If no root cause was pinpointed during earlier troubleshooting stages (e.g., by automated troubleshooting engine 506), issue aggregation and escalation engine 508 may employ troubleshooting agent 502 once again, this time the focus is on performing more targeted troubleshooting of the common elements identified. For instance, it may investigate the health of a specific router, or a network interface associated with the common issues.

Finally, issue aggregation and escalation engine 508 may document its findings, including the common elements it identified and any additional troubleshooting results, into a master ticket. This master ticket is then escalated to the next level of support teams for resolution. Moreover, as new support tickets matching the same master issue are generated, they are automatically cross-referenced to streamline the resolution process. New support tickets matching the same master issue are automatically referenced as they come in.

In various implementations, configuration and policy engine 510 may allow a support organization administrator to configure a set of constraints on the Virtual Assistant operations. To this end, several constraints can be configured, such as any or all of the following:
Issues of interest: which support queues and categories of issues for which the system should be engaged. For example, the agent may be asked to engage for wireless campus issues but not data center related ones.
Budget: what is the maximum token number (or cost) the agent can spend to perform the automated troubleshooting?
Past issue count: e.g., a count of past issues to be used for deriving the troubleshooting plan by automated troubleshooting engine 506.
Escalation cluster size: the minimum number of similar issues that issue aggregation and escalation engine 508 needs to identify before opening a master issue and escalating to the next level of support.

FIG. 6 illustrates an example 600 of the interactions of the components of the architecture in FIG. 5. As shown, assume that there are various end users in a network 602, such as end user 604a, end user 604b, and end user 604c. First, one or more of these users may open one or more new support tickets 606, such as via a user interface 516, which is sent to automated troubleshooting engine 506, as shown at (1).

In turn, automated troubleshooting engine 506 may perform a semantic search (and metadata filtering) of ticketing knowledge database 504 for the one or more new support tickets 606, as shown at (2). Then, automated troubleshooting engine 506 may leverage an LLM 608 to devise a troubleshooting plan, based on the k-number of past similar issues to those raised in the one or more new support tickets 606, as shown at (3). Automated troubleshooting engine 506 then sends the issue description and troubleshooting plan to troubleshooting agent 502, which uses this information to perform troubleshooting in network 602 and returns the identified root causes (RCAs) back to automated troubleshooting engine 506, at (4). Troubleshooting agent 502 or automated troubleshooting engine 506 may then formulate a notification of any actions that users 604 need to take to resolve the issue.

In cases when ticketing knowledge database 504 finds a group of new issues, at (5), it may notify issue aggregation and escalation engine 508. In turn, issue aggregation and escalation engine 508 may leverage an LLM 612 (e.g., the LLM of agent 502) to identify common elements (e.g., router, circuit, SO version, etc.) among the issue descriptions and logs 610, at (6). Issue aggregation and escalation engine 508 may then send ask troubleshooting agent 502 to troubleshoot the common elements 614, at (7). In addition, issue aggregation and escalation engine 508 may also aggregate tickets into a master issue 616 by seeking review from an L3 support team 620, at (8).

As noted above, different users may differ considerably in terms of their expectations and needs, when interacting with an LLM-based network troubleshooting system. For instance, Table 1 below illustrates different types of queries that different types of users may issue to troubleshooting agent 502:

TABLE 1

| Type of User | Query |
|---|---|
| End User | Is the wireless network working? |
| IT Support | Can you generate an SLA compliance |
| | report for my WAN circuit? |
| Compliance | Which devices in my network will be |
| Officer | EoL in the next 6 month? |
| Network | Can you root cause wireless issues at |
| Administrator | site Munich? |

In addition, these different types of users may need and expect different levels of detail in the response of troubleshooting agent 502. For instance, consider the case both an end user and a network administrator issuing the same query: “Is there an issue with the wireless network.” In the case of the end user, a response of “One access point in your location is experiencing issues,” should meet the expectations of that user. However, in the case of the network administrator, the response should include additional details such as, “Yes, AP XXX-XXX-XXX has rebooted 7 times in the last two hours. Here is a list of relevant logs: <logs>.” Indeed, information about the affected devices, network logs, or number of occurrences can help with a fast resolution. The conversation may continue with troubleshooting agent 502 also suggesting remediation steps such as rebooting the device or performing a software upgrade.

A further challenge with respect to different types of users is that different types of users require varying levels of QoS/SLA with respect to the troubleshooting system. Consider a scenario where a major network outage impacts hundreds of users, prompting them to query troubleshooting agent 502 for network status information. Each user request triggers troubleshooting agent 502 to initiate a troubleshooting workflow and query network controllers via APIs or SDKs for the latest information. The high volume of user requests can lead to API interface congestion, preventing both regular users and IT/Network administrators from accessing the system, thereby delaying issue resolution.

### --User Role-Aware Interactions by Network Troubleshooting LLM Agents--

The techniques herein enhance LLM-based network troubleshooting systems, such as the one described above, by adding capabilities to the system that take into account the user interacting with the system. More specifically, the techniques herein are able to distinguish between different types of users (user personas) based on their organization roles, levels of expertise, domains of interest, or other types of logic with the following goals:
Provide personalized responses based on user context, requirements, and level of expertise. Regular users may be provided with highly summarized responses, while network administrators receive very in-depth responses containing detailed information allowing them to quickly remediate issues.
Enforce Role Based Access Control (RBAC), such that users can be restricted to only have access to specific Agent topics (e.g., SD-WAN, FTD, DNAC, ISE, APIC, etc.) and functionality (available actions, e.g., reboot a device or start an upgrade).
Ability to adjust agent capabilities based on user persona/role. Advanced troubleshooting is dependent on strong reasoning capabilities provided by very large and capable models such as OpenAI's GPT-4. Some users may not require such capabilities, in such cases, smaller models tend to provide faster answers while being less resource and cost intensive and may be more appropriate.
Allow the troubleshooting agent to define and enforce SLAs, prioritizing requests from specific user groups (e.g., network administrators) over others (e.g., regular users, helpdesk staff). During periods of high demand, the system can grant higher priority access to expert users for network controller APIs and advanced LLM model resources. Regular user requests may be served on a best-effort basis and, in some cases, be limited to accessing only cached network data without direct access to network controller APIs.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein, such as in conjunction with network control process 248.

Specifically, according to various implementations, a device obtains a prompt from a user via a user interface that requests a network troubleshooting agent complete a task with respect to a computer network using one or more language models. The device determines instructions for the network troubleshooting agent based on a user group of which the user is a member. The device provides the prompt and the instructions to the network troubleshooting agent, to produce an answer. The device provides the answer to the user interface for review by the user.

Operationally, user management module 512 shown previously in FIG. 5 may be responsible for ensuring that the troubleshooting system takes into account the user interacting with troubleshooting agent 502, to tailor those interactions, accordingly. In various implementations, user management module 512 may include any or all of the following sub-components: a user context retriever 702, a persona-aware knowledge database 704, a persona instruction library 706, an LLM model catalog 708, a task QoS manager 710, and/or a management and monitoring module 712. The functionalities of these sub-components may be combined or omitted, as desired. In addition, some implementations also provide from these sub-components to be executed in a distributed manner.

In various implementations, user context retriever 702 may be responsible for creating and storing individual user profiles. To do so, in some instances, user context retriever 702 may interface with an identity management system, a corporate directory system, or a dedicated database for user details, to retrieve any or all of the following regarding a user that issues a prompt/request for input to troubleshooting agent 502:
User group: the role of the user in the team or overall organization/enterprise
A list of allowed/disallowed systems and access levels: users may have different access levels to different tools or systems. Some users may have full administrator rights on some systems (e.g., vManage controller), while having read-only (e.g., DNAC controller) or no access on others (e.g., APIC, ISE).
Skills and proficiency levels: information about the user's network skills and their level of expertise. This can be either inferred from the user's access level (e.g., a vManage controller administrator can be expected to have a certain level of understanding of corresponding concepts), from the user's function and role, or from other attributes.
Other information such as the user's location, preferred language, or assigned corporate devices (e.g., whether the user was issued a MacOS or Windows-based laptop).

A user may provide additional information such as additional topics of interest to user context retriever 702 either directly via the chat interface of troubleshooting agent 502 (e.g., the agent may periodically query the user to update their interests or preferences) or directly via the configuration interface of user management module 512.

User context retriever 702 may also allow a system administrator to define several user personas/groups corresponding to different types of users. For example, the different user groups may correspond to regular users, help desk engineers, network engineers, administrator, executive personnel, etc. These groups can then be made available to downstream components which can use this information to customize the responses of troubleshooting agent 502.

In one implementation, user context retriever 702 assigns a user persona/group to each user based on a rules-based system defined by the system administrator. In another implementation, user context retriever 702 may query a language model (e.g., an LLM) with the details of the user under consideration and available persona/group descriptions to determine the appropriate group for that user. In further implementations, the language model may detect that a specific user should be assigned to a different group based on their interaction with troubleshooting agent 502. For instance, troubleshooting agent 502 may detect that the user requests more (less) details. Additionally, the system may ask for summary feedback from the user, in order to determine whether the nature of the answer matched the expectations of the user.

In various implementations, persona-aware knowledge database 704 may take the form of a vector database such as Chroma or Pinecone. Persona-aware knowledge database 704 may also store information about the various APIs and SDKs that are available to troubleshooting agent 502 along with other domain or environment-specific documentation (e.g., troubleshooting recipes) as vector embeddings. Each document that is present in persona-aware knowledge database 704 may be tagged with a set of metadata fields such as any or all of the following:
allowed user personas/groups: a list of user personas/groups for which the document is in scope.
(system, required access level) tuple: in the case of APIs or SDK methods, the system (e.g.: DNAC, vManage, APIC etc.) along with the required access level are set. When multiple systems are referenced in the same document, (e.g., a troubleshooting recipe), the record in persona-aware knowledge database 704 may mention all systems and required access levels. Similarly, when a single record contains multiple APIs or SDK methods from the same system requiring different access levels, the most restrictive access level is recorded.

Like traditional knowledge databases, persona-aware knowledge database 704 may be queried for the top-K most relevant documents using semantic search as part of a retrieval-augmented generation (RAG). However, the RAG mechanism may also be updated to include not only the search text as vector embeddings but also the user persona/group information (e.g., user group label, allowed systems, etc.) as clear text. This information may then be used to perform initial filtering on persona-aware knowledge database 704 such that only documents the user should have access to are considered for semantic search. Additional metadata fields present in the user persona information such as location or domains of interest may be used as part of the semantic search to further refine the quality of the top-K returned results.

According to various implementations, further information that user management module 512 may obtain for a given user relate to how prompts/requests from that user are prioritized. Indeed, as described below, user management module 512 may also apply different SLAs to different user personas/groups. Indeed, different users may be assigned to different groups such as, but not limited to, any of the following:
Network Administrators: Users responsible for managing and administering the network infrastructure.
IT Support: Users working in various L1/L2 technical support roles.
End User: Regular users who are consumers of network services.

The capacity of troubleshooting agent 502 to respond to user queries is limited by several factors, including the provisioned LLM model(s), request per second or tokens per minute capacity, and overall system scalability and performance. Users can have different priorities for accessing the LLM queue based on their group. High-priority tasks may be addressed immediately, while lower-priority tasks may experience delays.

In addition, troubleshooting agent 502 may interact with network controller 514, such as Cisco's DNAC, vManage, Meraki controllers, or third-party NMS API interfaces, to retrieve live network data and respond to user queries. However, each network controller can only handle a certain number of API calls per second. Overloading the system with too many requests may lead to undesirable behavior. To mitigate this, some user requests may be answered with cached data if available.

Accordingly, in various implementations, each user group may have an associated SLA profile, that governs the user request priority and access to network data. As such, each SLA profile may consist of any or all of the following information:

### Request-Priority:

Best effort: the user query is serviced at a low priority. This category of request is the first to get dropped or delayed during periods of high utilization.
High: the user query is serviced with high priority. However, if the system becomes heavily congested, some requests in this category may also be dropped or delayed.
Strict priority: the user query takes priority over all other queries and is always executed.

### Data-Access-Priority:

Cache: The user query can only use cached data (data already retrieved by troubleshooting agent 502 for other queries). If the required data is not available in the cache, the user query will not be answered, and a standard message will be returned to the user (e.g., ‘Your request cannot be answered at this time.’). The duration for which data is cached may also be configurable.
Cache-when-available: The user query will be served using cached data when it is available, and using live data when it is not in cache.
Real-time: The user queries are always served using live network data (or very short-lived cache).

Other more granular requests or data priority categories may be defined.

In a more advanced implementation, a user group may leverage multiple SLA profiles that can be active at different times of the day or change based on system load, or network conditions (e.g.: whether an outage is present or not). Additionally, the SLA profiles may be extended to include a list of LLM models that each group of users is allowed access to, with lower priority requests being assigned less capable LLM models (either on a permanent basis or only temporarily as offload mechanisms during congestion times).

In various implementations, persona instruction library 706 may include a set of persona/group-specific prompt instructions for troubleshooting agent 502 as to how the language model should craft its answer a particular group of users. By way of example, for the end user group, persona instruction library 706 may provide the following instructions in conjunction with a prompt from an end user:
“You are a helpful and friendly agent designed to help end users with network-related queries and basic troubleshooting.
Important:
   You may only ask the user to perform troubleshooting on his her local device (laptop, phone, etc.).
   When local troubleshooting is required, provide clear step-by-step instructions.
   Only provide information relevant to the user's device (model type OS) and location. You can find these in the user profile section.
   Do not provide any information about specific network devices (hostnames, site IDs, device IDs, IPs, interface names, MAC addresses, network logs)
   Do not ask the user to perform any troubleshooting on network devices (APs, switches, routers) or network controllers.
   Do not ask the user to reboot, reset, or reconfigure any network device.”

The result is that the answer from troubleshooting agent 502 will be relatively simplistic and easier to understand by an end user. In addition, these instructions will also prevent the answer from requesting that the user perform any actions that would normally be performed by technical personnel.

Conversely, if the user group is for network administrators, persona instruction library 706 may determine that the following instructions should be sent to troubleshooting agent 502 in conjunction with a prompt/request from a network administrator:
“You are a helpful and friendly agent designed to help network administrators troubleshoot a customer network.
Your goal is to retrieve detailed information about the network and find the root cause of the reported issue.
Important:
   You must include a summary of the troubleshooting steps performed in your final answer.
   Include detailed information about the devices referenced in your answer.
   Include the relevant logs or information that contributed to your answer.
   Do not make assumptions, ask the network admin for help if you are not sure.
   Provide a list of potential remediation actions.
   Produce complete, human-readable answers, e.g., bullet points for lists, Markdown table for pandas DataFrames, etc.”

Thus, the prompt for a regular end user may include instructions for the LLM to focus on troubleshooting the local user endpoint devices (laptop, phone) while restricting the amount of network infrastructure details shared. In contrast, the prompt instructions for interacting with a network administrator persona may direct the LLM to focus on troubleshooting the network infrastructure, identify a root cause, and provide potential remediation actions all while providing full transparency (logs, device details, etc.).

The set of persona-specific instructions is only a subset of the overall prompt used by troubleshooting agent 502 and can then be expanded to include more general system instructions such as:
“
   Only produce one of Python or help blocks.
   Do not make assumptions about entities: ask for help if you are not sure.
   Do not print anything. Call the ‘answer ( . . . )’ function to answer the question if you can.
”

Note that, without loss of generality, persona instruction library 706 may apply instructions to prompts at multiple stages, e.g., personalizing the prompt when using a critic model as part of the assessment by troubleshooting agent 502. This is especially important to enforce safety (e.g., not giving away any critical data to an unauthorized user), as this will be more effectively performed by a model with a specific prompt to do so. Note, however, that one can generally never only rely on prompting to achieve security objectives, and it must typically be coupled with some other forms of control (e.g., adjusting the authorization of the agent depending on the persona of the user on behalf of whom the agent is performing the tasks).

In some implementations, LLM model catalog 708 may include a mapping between a list of available LLM models and user personas/groups, to control which LLM(s) troubleshooting agent 502 opts to use for a given prompt. Indeed, LLM models come in a variety of sizes and capabilities. Very large LLM models such as OpenAI's GPT-4 have been proven to be extremely capable and perform well when faced with diverse tasks, however, they come with a significant cost. Smaller, by comparison, models like GPT-3 or 3.5 may have slightly lower capabilities but come at a smaller resource cost and provide better response times. Other, even smaller, models can be trained or fine-tuned to excel at solving specific tasks: code writing, reasoning, data visualization etc., with the advantage of even lower cost, more flexibility, and better response times.

LLM model catalog 708 allows a system administrator to map different types of user personas/groups to different sets of models to optimize both performance (selecting models that perform well for most tasks coming from a specific user persona) and cost (allowing smaller models to be used where possible). For example, for personas where advanced troubleshooting capabilities are important (e.g.: Net-Admin) GPT-4 may be selected as it provides advanced reasoning capabilities. For personas that are not likely to need such advanced troubleshooting capabilities, GPT-3.5 or GPT-3 may be selected.

In one implementation, mapping in LLM model catalog 708 may be static, with personas always being mapped to the same set of models/capabilities. In another implementation, LLM model catalog 708 may allow the configuration of cost caps per user persona, such that while initially the most capable set of models is provided, should a specific cost threshold be exceeded the system can revert to more cost-effective, usually less capable, models.

In various implementations, task QoS manager 710 may provide advanced classification, queuing, and scheduling mechanisms for troubleshooting agent 502, enabling multiple SLA levels to be enforced. As previously mentioned, for each user request, troubleshooting agent 502 initiates a troubleshooting workflow and queries network controllers via APIs or SDKs to fetch the latest network information. During major outages, a large number of users may simultaneously query troubleshooting agent 502, causing congestion in the back-end API interfaces towards various network controllers and resulting in poor overall system performance. In such cases, prioritizing requests from network administrators tasked with troubleshooting and remediation over those from regular users is critical.

To this end, the task QoS manager 710 may perform any or all of the following:
Task Classification: for each new request, task QoS manager 710 may extract the user details from the request and perform a lookup for the appropriate priority labels for the user group associated with that request.
Task Queueing: task QoS manager 710 may then assign the user requests to a set of queues based on the request priority labels. Each queue (best-effort, high, strict-priority) has a configurable queue depth specifying the maximum number of requests that can be buffered. Once the threshold is reached, new requests are automatically rejected on a per-queue basis. Task QoS manager 710 may also assign each queue an execution weight that governs how often the queue is serviced.
Task Execution Scheduling: task QoS manager 710 may use a weighted round-robin algorithm to retrieve tasks from the queues, ensuring higher priority queues are serviced more frequently. A strict priority queue can also be configured, ensuring that some requests always take precedence.
API Caching: in some implementations, task QoS manager 710 may also utilize a smart caching mechanism to reduce the load on back-end APIs by storing API responses for a specified duration.

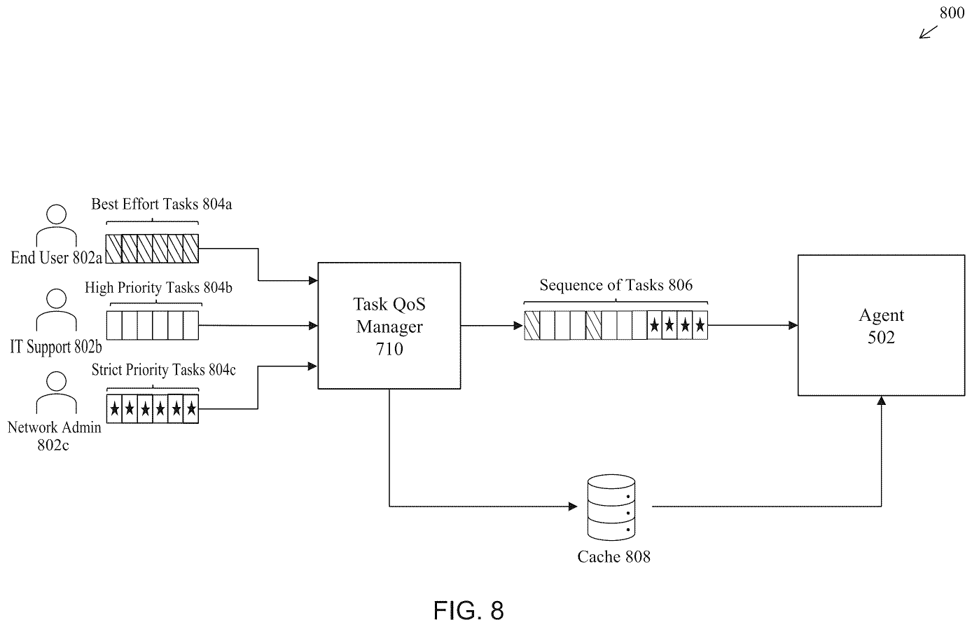

FIG. 8 illustrates an example 800 of user-aware task scheduling for an LLM-based network troubleshooting agent, in various implementations. As shown, assume that there are three different users, each belonging to a different user group: an end user 802a, an IT support user 802b, and a network administrator 802c. Associated with each of their user groups may be different SLA requirements. For instance, tasks 804a from end user 802a may be considered best effort, tasks 804b from IT support user 802b may be considered high priority, and tasks 804c from network administrator 802c may be considered strict priority.

By assigning a priority to each of the tasks (e.g., prompts) for processing by troubleshooting agent 502, task QoS manager 710 may formulate a sequence of tasks 806 according to the priorities of tasks 804a-804c. For instance, task QoS manager 710 may allow tasks 804c to take precedence over those of tasks 804b and tasks 804a, because those tasks are strict priority. Similarly, tasks 804b may take priority over tasks 804a in sequence of tasks 806 since they are of higher priority. In some instances, since best effort tasks 804a are of the lowest priority, task QoS manager 710 may even force some (or all) of them to be processed by troubleshooting agent 502 using cached data from cache 808, instead of real-time information from the network.

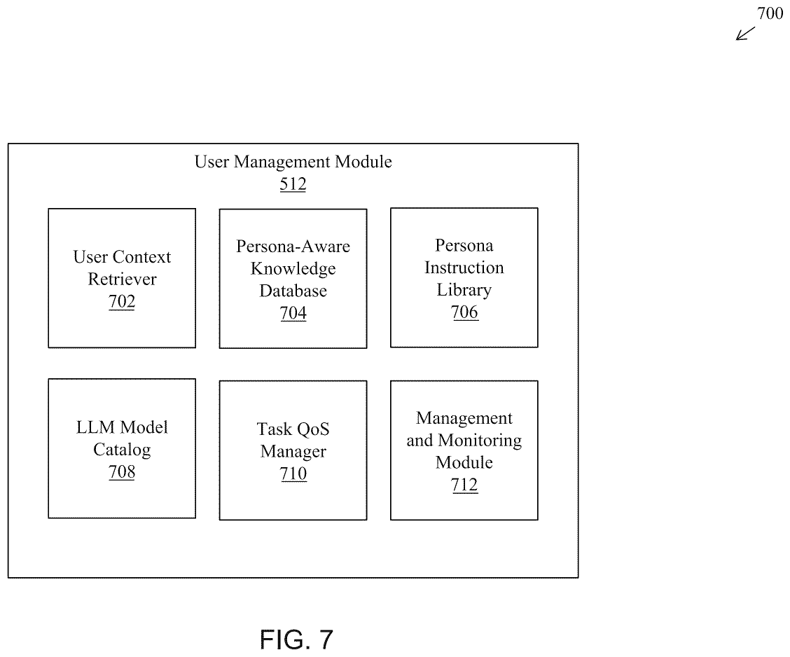

Referring again to FIG. 7, task QoS manager 710 may also be configured to always enforce the data-access-priority labels, such that regardless of the system load, some users can only use cache data.

In other implementations, task QoS manager 710 may enforce the data access priorities based on system load, such that:
in low load conditions: the system tries to serve all users with the best quality data (real-time)
in high load scenarios (e.g.: a specific load threshold of troubleshooting agent 502 is reached) the low-priority task queues can be configured to only have access to cached data allowing tasks in these queues to be completed faster (as the data already exists in the system) without placing additional strain on the backend APIs.

The second approach may be more desirable since using cached data may reduce accuracy due to potential changes in the network state and may expose an inconsistent view of the network if different pieces of data were cached at different times. Tasks in high-priority queues either bypass the cached data entirely in both scenarios or use a very short-term cache (a few seconds). The duration for which API responses are cached can also be dynamically adjusted based on load levels, with responses being cached for longer periods as the system load increases.

In various implementations, management and monitoring module 712 may perform the following:
Allows the system administrator to define configuration parameters such as:
   User groups
   SLA profiles
   Queue length and weight
   Cache timers
Enables the system administrator to monitor the behavior of the system such as:
   queue usage statistics (average, maximum)
   queue drop statistics
   cache hits

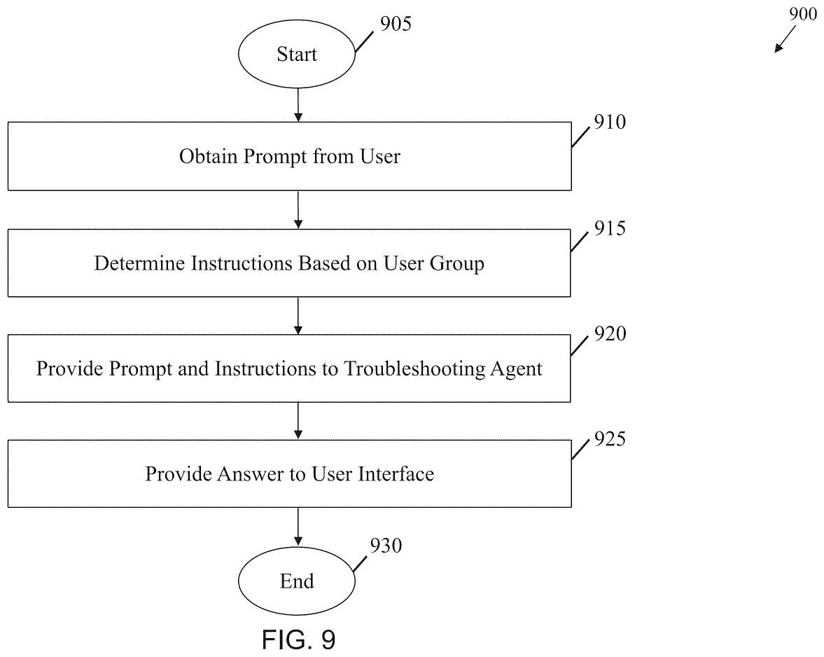

FIG. 9 illustrates an example simplified procedure (e.g., a method) for providing user role-aware interactions by LLM-based network troubleshooting agents, in accordance with one or more implementations described herein. For example, a non-generic, specifically configured device (e.g., device 200), such as a router, firewall, controller for a network (e.g., an SDN controller or other device in communication therewith), server, or the like, may perform procedure 900 by executing stored instructions (e.g., language model process 249 and/or network control process 248). The procedure 900 may start at step 905, and continues to step 910, where, as described in greater detail above, the device may obtain a prompt from a user via a user interface that requests a network troubleshooting agent complete a task with respect to a computer network using one or more language models. In various implementations, the one or more language models comprise a large language model (LLM).

At step 915, as detailed above, the device may determine instructions for the network troubleshooting agent based on a user group of which the user is a member. In various implementations, the user group is associated with at least one of: a group of one or more end users, a group of one or more network administrators, or a group of one or more technical support personnel.

At step 920, the device may provide the prompt and the instructions to the network troubleshooting agent, to produce an answer, as described in greater detail above. In some implementations, the instructions include a request that the network troubleshooting agent include in the answer at least one of: log data from networking equipment in the computer network that is referenced in the answer, detailed information about that networking equipment, or potential remediation actions. In other implementations, the instructions include a request that the network troubleshooting agent exclude from the answer of at least one of: log data from networking equipment in the computer network that is referenced in the answer, detailed information about that networking equipment, or potential remediation actions. In one implementation, the instructions include a request that the network troubleshooting agent use a particular language model to process the prompt. In further implementations, the instructions indicate whether the network troubleshooting agent is allowed to access a particular document, system, or application programming interface (API).

In various implementations, the device may also determine a priority for the prompt, based on the user group and insert the prompt into a sequence of prompts for processing by the network troubleshooting agent based on the priority of the prompt. In some cases, the device may store the prompt in a cache, prior to providing the prompt to the network troubleshooting agent, based on the priority of the prompt. In one implementation, the device may also receive a service level agreement profile for association with the user group that controls the priority of the prompt.

At step 925, as detailed above, the device may provide the answer to the user interface for review by the user.

Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for providing user role-aware interactions by LLM-based network troubleshooting agents, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
obtaining, by a device, a prompt from a user via a user interface that requests a network troubleshooting agent complete a task with respect to a computer network using one or more language models;
determining, by the device, instructions for the network troubleshooting agent based on a user group of which the user is a member;
providing, by the device, the prompt and the instructions to the network troubleshooting agent, to produce an answer; and
providing, by the device, the answer to the user interface for review by the user.

2. The method as in claim 1, wherein the user group is associated with at least one of: a group of one or more end users, a group of one or more network administrators, or a group of one or more technical support personnel.

3. The method as in claim 1, wherein the instructions include a request that the network troubleshooting agent include in the answer at least one of: log data from networking equipment in the computer network that is referenced in the answer, detailed information about that networking equipment, or potential remediation actions.

4. The method as in claim 1, wherein the instructions include a request that the network troubleshooting agent exclude from the answer of at least one of: log data from networking equipment in the computer network that is referenced in the answer, detailed information about that networking equipment, or potential remediation actions.

5. The method as in claim 1, further comprising:
determining a priority for the prompt, based on the user group; and
inserting the prompt into a sequence of prompts for processing by the network troubleshooting agent based on the priority of the prompt.

6. The method as in claim 5, further comprising:
storing the prompt in a cache, prior to providing the prompt to the network troubleshooting agent, based on the priority of the prompt.

7. The method as in claim 5, further comprising:
receiving a service level agreement profile for association with the user group that controls the priority of the prompt.

8. The method as in claim 1, wherein the instructions include a request that the network troubleshooting agent use a particular language model to process the prompt.

9. The method as in claim 1, wherein the instructions indicate whether the network troubleshooting agent is allowed to access a particular document, system, or application programming interface (API).

10. The method as in claim 1, wherein the one or more language models comprise a large language model (LLM).

11. An apparatus, comprising:
one or more network interfaces;
a processor coupled to the one or more network interfaces and configured to execute one or more processes; and
a memory configured to store a process that is executable by the processor, the process when executed configured to:
obtain a prompt from a user via a user interface that requests a network troubleshooting agent complete a task with respect to a computer network using one or more language models;
determine instructions for the network troubleshooting agent based on a user group of which the user is a member;
provide the prompt and the instructions to the network troubleshooting agent, to produce an answer; and
provide the answer to the user interface for review by the user.

12. The apparatus as in claim 11, wherein the user group is associated with at least one of: a group of one or more end users, a group of one or more network administrators, or a group of one or more technical support personnel.

13. The apparatus as in claim 11, wherein the instructions include a request that the network troubleshooting agent include in the answer at least one of: log data from networking equipment in the computer network that is referenced in the answer, detailed information about that networking equipment, or potential remediation actions.

14. The apparatus as in claim 11, wherein the instructions include a request that the network troubleshooting agent exclude from the answer of at least one of: log data from networking equipment in the computer network that is referenced in the answer, detailed information about that networking equipment, or potential remediation actions.

15. The apparatus as in claim 11, wherein the process when executed is further configured to:
determine a priority for the prompt, based on the user group; and
insert the prompt into a sequence of prompts for processing by the network troubleshooting agent based on the priority of the prompt.

16. The apparatus as in claim 15, wherein the process when executed is further configured to:
store the prompt in a cache, prior to providing the prompt to the network troubleshooting agent, based on the priority of the prompt.

17. The apparatus as in claim 15, wherein the process when executed is further configured to:
receive a service level agreement profile for association with the user group that controls the priority of the prompt.

18. The apparatus as in claim 11, wherein the instructions include a request that the network troubleshooting agent use a particular language model to process the prompt.

19. The apparatus as in claim 11, wherein the instructions indicate whether the network troubleshooting agent is allowed to access a particular document, system, or application programming interface (API).

20. A tangible, non-transitory, computer-readable medium storing program instructions that cause a device to execute a process comprising:
obtaining, by the device, a prompt from a user via a user interface that requests a network troubleshooting agent complete a task with respect to a computer network using one or more language models;
determining, by the device, instructions for the network troubleshooting agent based on a user group of which the user is a member,
providing, by the device, the prompt and the instructions to the network troubleshooting agent, to produce an answer, and
providing, by the device, the answer to the user interface for review by the user.
